(19) United States
(12) Patent Application Publication
(10) Pub. No.: US 2024/0097376 A1
(43) Pub. Date: Mar. 21, 2024

(54) COMPACT WATER RESISTANCE ELECTRICAL CONNECTOR

(71) Applicant: Amphenol East Asia Electronic Technology (Shenzhen) Co., Ltd., Shenzhen (CN)

(72) Inventors: Hui Wen Liu, Shenzhen (CN); Zhimin Qin, Shenzhen (CN)

(73) Assignee: Amphenol East Asia Electronic Technology (Shenzhen) Co., Ltd., Shenzhen (CN)

(21) Appl. No.: 18/467,971

(22) Filed: Sep. 15, 2023

(30) Foreign Application Priority Data
Sep. 21, 2022 (CN) 202222510669.8

(51) Int. Cl. H01R 13/52; H01R 13/422

(52) U.S. Cl. CPC H01R 13/5202; H01R 13/422; H01R 13/5216

(57) ABSTRACT

Compact electrical connectors with improved water resistance. A connector may have an outer shell and an inner shell disposed in the outer shell. A lead assembly may be partially disposed in the inner shell. A mating end of one of the outer shell and inner shell may extend beyond a mating end of the other shell, defining a corner. A seal may be disposed in the corner, such that the seal is mechanically supported when the connector is pressed, in a mating direction, against a mating component, blocking ingress of environmental contaminants. The seal may also block any opening between the mating end of the outer and inner shells. The seal is made from a curable material such that it may readily fill such an opening. The connector may also have a body seal in the lead assembly.

### RELATED APPLICATIONS

This application claims priority to and the benefit of Chinese Patent Application Serial No. 202222510669.8, filed on Sep. 21, 2022, entitled “ELECTRICAL CONNECTOR,” which is herein incorporated by reference in its entirety.

### FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many connectors may be mounted. Conducting traces in the backplane may be electrically connected to signal conductors in the connectors so that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting printed circuit boards. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time.

Some USB connectors water resistant. These connectors may include seals that block water from outside the computer enclosure from entering the computer enclosure through the opening left for the connector.

### BRIEF SUMMARY

Aspects of the present application relate to compact water resistance electrical connectors.

Some embodiments relate to an electrical connector. The electrical connector may comprise a lead assembly comprising a body portion and a plurality of conductive elements held by the body portion; an inner shell disposed outside the lead assembly, the inner shell at least partially enclosing the body portion of the lead assembly and comprising a mating end; an outer shell disposed outside the inner shell and connected to the inner shell at selected locations, the outer shell comprising a mating end, wherein the mating end of the inner shell extends beyond the mating end of the outer shell; and a seal attached to both the inner shell and the outer shell.

Optionally, the electrical connector may comprise a corner portion between a surface of the mating end of the inner shell and a surface of the mating end of the outer shell, wherein the seal may be disposed in the corner portion.

Optionally, the seal may be attached to at least a portion of a surface of the mating end of the inner shell, and the portion of the surface of the inner shell may extend, in the mating direction, beyond the outer shell.

Optionally, the seal may be attached to at least a portion of a surface of the mating end of the outer shell, and the surface of the outer shell may be transverse to the surface of the inner shell.

Optionally, the seal may be made from a UV curable adhesive.

Optionally, the mating end of the outer shell may comprise a flange portion extending outward of the outer shell; and the corner portion may be between the surface of the mating end of the inner shell and a surface of the flange portion of the mating end of the outer shell.

Optionally, the seal may be elastically deformable.

Optionally, the seal may have a length of substantially 0.50 mm in the mating direction at a rest state; and the seal may be configured to produce an elastic deformation, in the mating direction, in a range of 0.10 mm to 0.25 mm.

Optionally, the body portion of the lead assembly may comprise an opening that exposes portions of the plurality of conductive elements; and the electrical connector may comprise a body seal disposed in the opening of the body portion of the lead assembly.

Optionally, the outer shell may comprise a window aligned with the opening of the body portion of the lead assembly.

Optionally, the lead assembly may comprise a tongue portion extending from the body portion in a mating direction and exposed at the mating end of the inner shell.

Some embodiments relate to an electrical connector. The electrical connector may comprise: an outer shell comprising a mating end; an inner shell disposed in the outer shell and comprising a mating end extending beyond the mating end of the outer shell; a lead assembly comprising a body portion at least partially disposed in the inner shell and a plurality of conductive elements held by the body portion; and a seal disposed on a surface of the mating end of the inner shell so as to block a path between the mating end of the inner shell and the mating end of the outer shell.

Optionally, the seal may comprise a first surface attached to the surface of the mating end of the inner shell, a second surface attached to a surface of the mating end of the outer shell, and a third surface connecting the first surface and the third surface; and the third surface may be within a perimeter of the outer shell.

Optionally, the third surface of the seal may be configured to deform in a mating direction when the electrical connector may be mated with a port of an electronic device.

Optionally, the outer shell may comprise a front portion and a rear portion separate from the front portion; the front portion may comprise the mating end of the outer shell; and the rear portion may comprise mounting tails.

Optionally, the electrical connector may further comprise connected spots between the outer shell and the inner shell.

Optionally, the inner shell may comprise a mounting end opposite the mating end; and the mating end of the inner shell may have a cross-sectional area larger than that of the mounting end.

Some embodiments relate to an electronic device. The electronic device may comprise a chassis comprising a port; and an electrical connector mated with the chassis. The electrical connector may comprise an outer shell comprising a mating end facing the port of the chassis; an inner shell disposed in the outer shell and comprising a mating end facing the port of the chassis and extending beyond the mating end of the outer shell; a plurality of conductive elements at least partially disposed in the inner shell; and a seal attached to both the inner shell and the outer shell and abutting the chassis.

Optionally, the chassis may comprise a recess; and the seal of the electrical connector may be disposed in the recess.

Optionally, the chassis may comprise a protrusion in the recess; and the protrusion engages the seal of the electrical connector.

Some embodiments relate to an electrical connector. The electrical connector may include: a lead assembly including a tongue portion to be connected to a circuit of an electronic device by inserting the tongue portion into a port of the electronic device; an inner shell disposed on the outside of the lead assembly, the inner shell enclosing at least a portion of the lead assembly and exposing the tongue portion from a mating end of the inner shell; and an outer shell disposed on the outside of the inner shell and the lead assembly, wherein the mating end of the inner shell may extend beyond an mating end of the outer shell in a mating direction in which the electrical connector is inserted into the port of the electronic device, and a corner portion is formed between an outer sidewall surface of the inner shell that may extend beyond the mating end of the outer shell and a mating end surface of the outer shell, and the electric connector may further include a UV seal arranged at the corner portion, the UV seal may be attached to an outer sidewall surface of the inner shell that may extend beyond the mating end of the outer shell and attached to the mating end surface of the outer shell.

Optionally, the mating end of the outer shell may include a flange portion continuously arranged along a circumference direction of the outer shell, wherein the flange portion may extend radially towards the outer side of the outer shell and may form the mating end surface of the outer shell for attaching the UV seal.

Optionally, the UV seal may be an elastically deformable part, and the UV seal may be configured to produce an elastic deformation when the UV seal is inserted into the port of the electronic device and contacts with a chassis of the electronic device, so that an interference fit may be produced between the UV seal and the chassis of the electronic device in the mating direction.

Optionally, the UV seal may have a length of substantially 0.50 mm in the mating direction at a rest state, and the UV seal may be configured to produce an elastic deformation in the range of 0.1 mm to 0.25 mm, preferably 0.15 mm, in the mating direction.

Optionally, the UV seal may be configured to have an annular shape continuously extending along a circumference direction around the mating end of the inner shell, and the UV seal may be configured to have a first surface, a second surface and a third surface, wherein the first surface may form a positive fit with the outer sidewall surface of the inner shell that may extend beyond the mating end of the outer shell, the second surface may form a positive fit with the mating end surface of the outer shell, and the third surface may connect the first surface and the second surface.

Optionally, the third surface may be in a convex arc shape.

Optionally, a size of the mating end of the outer shell in a direction perpendicular to the mating direction may be smaller than a size, in the corresponding direction, of the port of the electronic device, into which the electrical connector may be inserted.

Optionally, a rib and/or a groove may be arranged on the mating end surface of the outer shell, and a groove and/or a rib may be correspondingly provided on the second surface of the UV seal to form a positive fit with the respective rib and/or the respective groove on the mating end surface of the outer shell.

Optionally, the rib and/or the groove formed on the mating end surface of the outer shell may be configured into an integral annular structure extending continuously along the circumference direction of the outer shell, or into a plurality of separate sections that may be spaced apart from each other along the circumference direction of the outer shell.

Optionally, the lead assembly may further include a body portion arranged on a mounting end of the lead assembly opposite to the tongue portion thereof, an opening may be arranged at the body portion and may expose the portions of the conductive elements, and a body seal may be tightly fit in the opening.

Optionally, the outer shell may be provided with a processing window for operating on the portions of the conductive elements, and in an assembly state of the electrical connector, the processing window may correspond to the opening fit with the body seal.

Optionally, the body seal may be made from a water resistance material.

Some embodiments relate to a method for manufacturing an electrical connector. The method may include: manufacturing a lead assembly by a two-step insert molding, wherein the lead assembly may include a tongue portion configured to be connected to a circuit of an electronic device by inserting the tongue portion into a port of the electronic device and a body portion arranged on the mounting end of the lead assembly opposite to the tongue portion thereof; providing an inner shell; disposing the inner shell on the outside of the lead assembly such that the inner shell may cover at least a portion of the lead assembly and the tongue portion of the lead assembly may be exposed from the mating end of the inner shell; providing an outer shell; disposing the outer shell on the outside of the inner shell and the lead assembly, wherein the outer shell may be disposed such that: the mating end of the inner shell may extend beyond the mating end of the outer shell in the mating direction in which the electrical connector is inserted into the port of the electronic device, and a corner portion may be formed between the outer sidewall surface of the inner shell that may extend beyond the mating end of the outer shell and the mating end surface of the outer shell; and applying a UV adhesive at the corner portion along the circumference direction of the inner shell and irradiating the UV adhesive with ultraviolet light, such that the UV adhesive may be cured to form a UV seal at the corner portion, wherein the UV seal may be attached to the outer sidewall surface of the inner shell that may extend beyond the mating end of the outer shell and may be also attached to the mating end surface of the outer shell.

Optionally, providing the outer shell may include: forming a flange portion continuously at the mating end of the outer shell along the circumference direction of the outer shell, wherein the flange portion may extend radially towards the outer side of the outer shell and form a mating end surface of the outer shell for attaching the UV seal.

Optionally, providing the outer shell may include: configuring a processing window for operating on the portions of the conductive elements of the lead assembly on the outer shell; and wherein the manufacturing the lead assembly by the two-step insert molding may include: configuring an opening at the body portion to expose the portions of the conductive elements; and the method may further include: providing a body seal; and tightly fitting the body seal in the opening of the body portion, such that the body seal may completely cover the connecting terminals exposed from the body portion.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 shows a top perspective view of an electrical connector, according to some embodiments.

FIG. 2 shows a bottom perspective view of the electrical connector of FIG. 1, according to some embodiments.

FIG. 3 shows an exploded schematic diagram of the electrical connector of FIG. 1, according to some embodiments.

FIG. 4 shows a perspective view of the electrical connector of FIG. 1 mated with a chassis, according to some embodiments.

FIG. 5 shows a front view of the mated electrical connector and chassis of FIG. 4, according to some embodiments.

FIG. 6 shows a cross-sectional view of the mated electrical connector and chassis of FIG. 4, taken along the A-A line in FIG. 5, according to some embodiments.

FIG. 7 shows a cross-sectional view of the mated electrical connector and chassis of FIG. 4, taken along the B-B line in FIG. 5, according to some embodiments.

FIG. 8 shows an enlarged view of the area R in FIG. 7, according to some embodiments.

FIG. 9 shows a front, top perspective view of an electrical connector, according to some embodiments.

FIG. 10 shows a front, bottom perspective view of the electrical connector of FIG. 9, according to some embodiments.

FIG. 11 shows an exploded perspective view of the electrical connector of FIG. 9, according to some embodiments.

FIG. 12A shows a flowchart of a method for manufacturing an electrical connector, according to some embodiments.

FIG. 12B shows a flowchart of a method for manufacturing an electrical connector, according to some embodiments.

FIG. 13 shows a flowchart of a method for manufacturing an electrical connector, according to some embodiments.

### DETAILED DESCRIPTION

The Inventors have recognized and appreciated connector designs that enable connectors to both be more compact and have improved water resistance. With the increasing use of portable electronic devices, it becomes more likely for the portable electronic devices to be exposed to moisture, dust or other environmental contaminants. For example, users may want to use electronic devices around water, such as when washing vegetables or taking a bath. If moisture enters the charging ports of the electronic devices, the electronic devices could be damaged. Conventional connectors may have a seal that is formed by molding. The molded seal may have features such as projections for fitting in the connectors and/or for creating interference with a chassis of an electronic device in a direction perpendicular to a mating direction of the electrical connector. These features increase the height and/or width of a connector and make connectors bulkier. Further, there may still be gaps between the connector and the molded seal.

In some examples, a connector may have an outer shell, an inner shell disposed in the outer shell and with a mating end extending beyond a mating end of the outer shell, and a lead assembly partially disposed in the inner shell. The lead assembly may include a body portion and conductive elements held by the body portion. A corner portion may be formed between a surface of the mating end of the inner shell and a surface of the mating end of the outer shell. A seal may be disposed in the corner portion and block a path between the mating end of the inner shell and the mating end of the outer shell. The seal may be made from a UV curable adhesive material. The seal may be configured to deform in the mating direction so as to create an interference with a chassis of an electronic device in the mating direction.

In some examples, the seal may have surfaces attached to the surface of the mating end of the inner shell and the surface of the mating end of the outer shell, respectively. With such configuration, any gap at a path between the inner shell and the outer shell of the electrical connector can be sealed seamlessly to reduce the risk of environmental contaminants entering the interior of the electrical connector. Alternatively or additionally, the surface of the mating end of the outer shell can be used as the support base for the seal. The seal can form an interference fit with the chassis of the electronic device in the mating direction when the electrical connector is inserted into the port of the electronic device. A tight and effective seal can be produced between the electrical connector and the chassis of the electronic device, reducing the risk of environmental contaminants entering the interior of the electronic devices through the ports of electronic devices and improving the safety of electronic devices. In addition, compared with a molded seal that creates interference with a chassis of an electronic device in the direction perpendicular to the mating direction of the electrical connector, a seal incorporating techniques as described herein may be configured to create an interference between the seal and the chassis of the electronic device in the mating direction of the electrical connector. Such a configuration can reduce the wear of the seal caused by contact friction between the seal and the side wall of the port, improving the effectiveness of sealing, prolonging the service life of the seal, and saving costs. Such a configuration also enables the electrical connector to be more compact.

Optionally, the seal may be configured to have an annular shape continuously extending circumferentially around the mating end of the inner shell. The seal may be configured to have a first surface, a second surface and a third surface. The first surface may form a positive fit with the outer sidewall surface of the inner shell, the second surface may form a positive fit with the mating end surface of the outer shell, and the third surface may connect the first surface and the second surface. The third surface may be smooth. The third surface may be within a perimeter of the outer shell. With such configuration, a tight fit can be achieved between the seal and the surface of the mating end of the inner shell and between the seal and the surface of the mating end of the outer shell, respectively. Therefore, any gap at a path between the inner shell and the outer shell of the electrical connector can be seamlessly sealed to reduce the risk of environmental contaminants entering the interior of the electrical connector, thereby improving the water resistance property of the electrical connector itself. Alternatively or additionally, a more compact electrical connector can be achieved.

In some examples, a body seal may be disposed in an opening of the body portion adjacent a mounting end of the electrical connector. With such a configuration, moisture, dust, etc. can be blocked from entering the interior of the electrical connector from the outside through the opening on the body portion that exposes portions of the conductive elements to cause damage to the connection terminal, thereby in turn improving the water resistance of the electrical connector. This would also block contaminants from passing through the electrical connector to the interior of the electronic device that includes the electrical connector. In addition, in some examples, both a front seal and a body seal are included. Interference fit may be formed between the front seal and the chassis of electronic devices. With such a configuration, the water resistance and dust resistance performance of electronic devices can be improved from several aspects, thereby achieving a high level of water resistance in a compact connector.

Some embodiments relate to methods for manufacturing the electrical connector described herein. A method may include applying an adhesive in the corner portion formed between the surface of the mating end of the inner shell and the surface of the mating end of the outer shell and along the circumference direction of the inner shell. The method may also include irradiating the adhesive with ultraviolet (UV) light, such that the adhesive is cured to form a seal in the corner portion. The seal may be manufactured in a higher speed because the adhesive may be cured in a few seconds to tens of seconds, reducing manufacturing cost and enabling robust manufacturing.

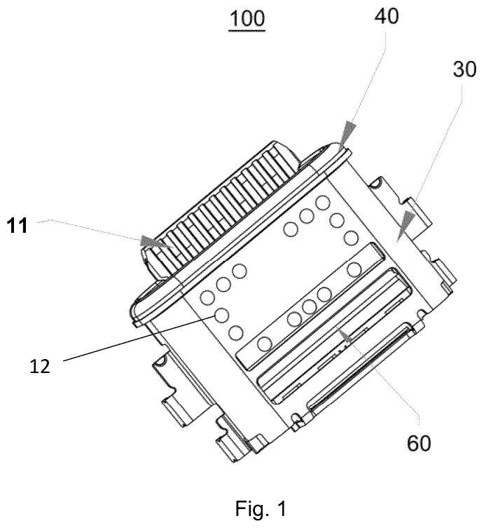

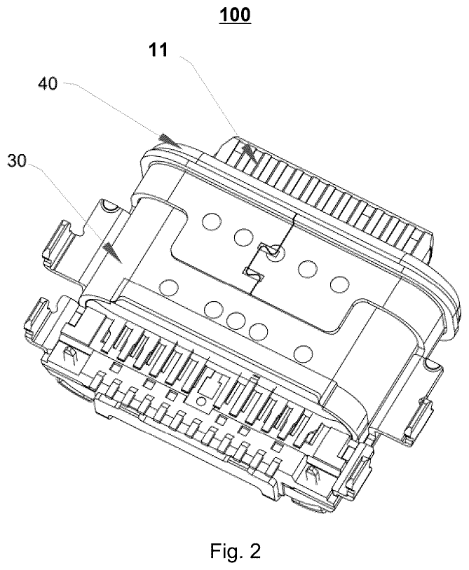

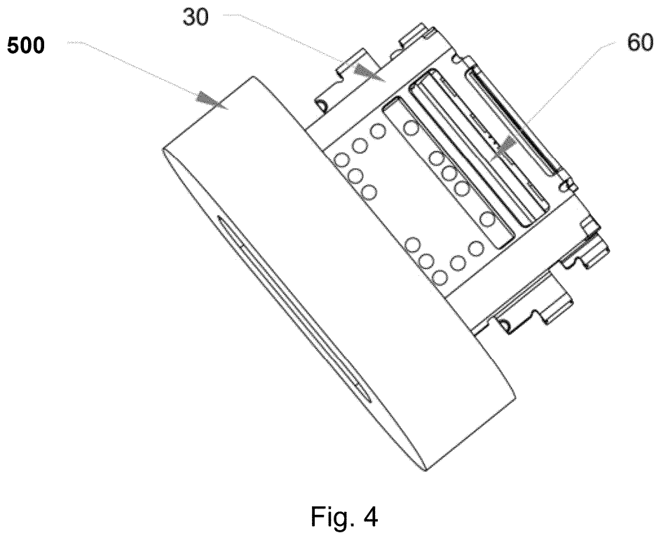

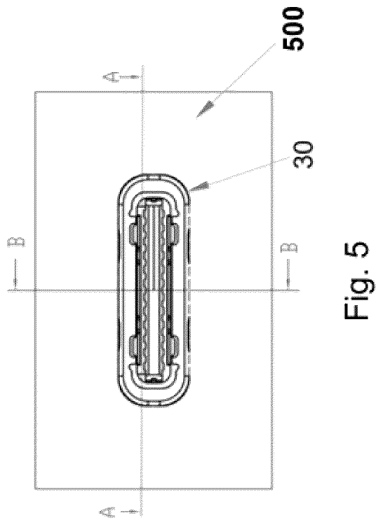

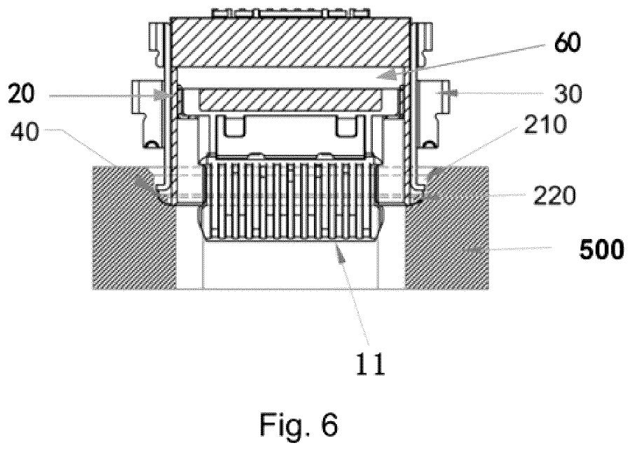

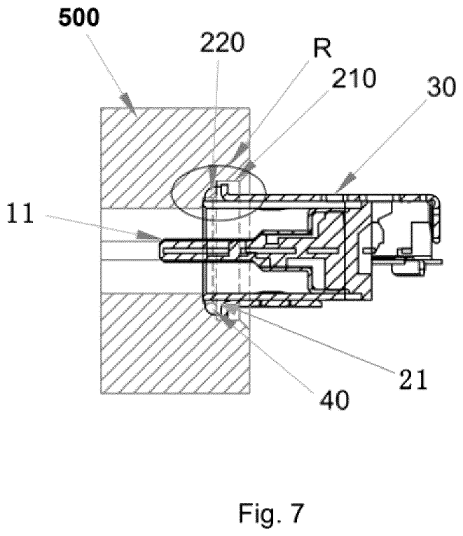

Referring to FIGS. 1 to 8, an electrical connector 100 according to the exemplary embodiment of the present application may include a lead assembly 10, a inner shell 20, an outer shell 30, and a front seal 40 arranged between the inner shell 20 and the outer shell 30. The lead assembly 10 of the electrical connector 100 may include conductive elements for electrically connecting with a circuit (not shown) of an electronic device. The inner shell 20 and the outer shell 30 may be made from metal materials, such as iron, aluminum and their alloys. Optionally, the inner shell 20 and the outer shell 30 may be respectively a main iron housing and an outer iron housing made from iron. In some embodiments, the conductive elements may include two rows of conductive elements. The lead assembly 10 may further include a shielding element (see, e.g., FIG. 7) between the conductive elements, where the shielding element is configured to shield the signal interference between two rows of conductive elements. In addition, the lead assembly 10 may further include an insulative portion (see, e.g., FIG. 7) arranged between the conductive elements for separating two rows of conductive elements from each other.

As shown in FIGS. 1 to 3, the lead assembly 10 includes a tongue portion 11 configured to be connected to a circuit of an electronic device by inserting the tongue portion into a port of the electronic device. The inner shell 20 of the electrical connector 100 may be disposed on the outside of the lead assembly 10 and may be configured to cover at least a portion of the lead assembly 10 and expose the tongue portion 11 from a mating end of the inner shell. The outer shell 30 of the electrical connector 100 may be disposed on the outside of the inner shell and the lead assembly. The outer shell 30 may be connected to the inner shell 20 at selected locations 12. The connections between the outer shell 30 and the inner shell 20 may be formed through, for example, spot welding.

In the illustrated embodiment, the mating end of the inner shell extends beyond the mating end of the outer shell in the mating direction in which the electrical connector is inserted into the port of the electronic device. A corner portion 21 is formed between the outer sidewall surface of the inner shell 20 that extends beyond the mating end of the outer shell 30 and the mating end surface of the outer shell 30, as shown in FIG. 7.

It can be understood that the term “mating end” used in the description of the present application may refer to the end of the corresponding part that is located on the forward side in the mating direction in which the electrical connector is inserted into the port of the electronic device, and the term “mounting end” may refer to the end of the corresponding part that is located away from the forward side in the mating direction in which the electrical connector is inserted into the port of the electronic device. In other words, “mounting end” and “mating end” may respectively indicate two opposite ends of corresponding part in the mating direction in which the electrical connector is inserted into the port of the electronic device.

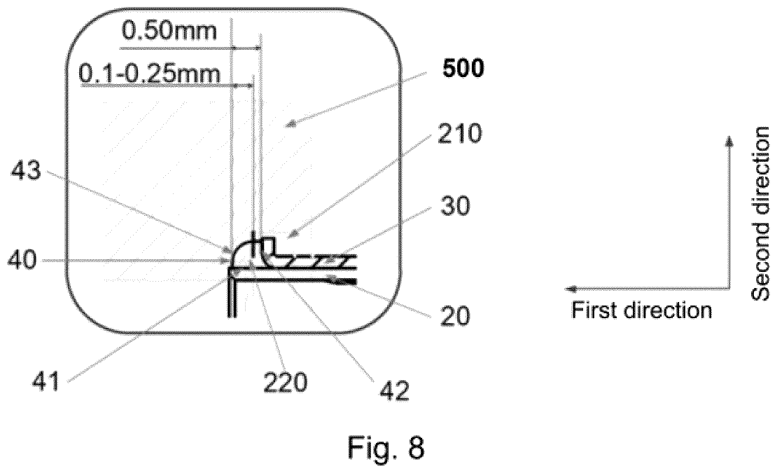

In the illustrated embodiment, the electrical connector 100 may also include a front seal 40 arranged at the corner portion. As shown in FIGS. 7 and 8, the front seal 40 is attached to the outer sidewall surface of the inner shell that extends beyond the mating end of the outer shell and is also attached to the mating end surface of the outer shell. In some embodiments, the front seal 40 may be made from UV curable adhesives and therefore referred to as UV seal.

According to the exemplary embodiment of the present application, a corner portion is formed between the outer sidewall surface of the inner shell that extends beyond the mating end of the outer shell and the mating end surface of the outer shell of the electrical connector, and a UV seal is arranged at the corner portion, such that the UV seal is attached to the outer sidewall surface of the inner shell that extends beyond the mating end of the outer shell and is also attached to the mating end surface of the outer shell. With such configuration, on the one hand, any gap at a path between the inner shell and the outer shell of the electrical connector can be sealed seamlessly to reduce the risk of environmental contaminants entering the interior of the electrical connector, and on the other hand, the UV seal uses the mating end surface of the outer shell as the support base, as a result, the UV seal can form an interference fit with the chassis of the electronic device in the mating direction when the tongue portion of the electrical connector is inserted into the port of the electronic device, so that a tight and effective seal is produced between the electrical connector and the chassis of the electronic device, thereby preventing environmental contaminants from entering into the interior of the electronic devices through the ports of electronic devices, and thus improving the safety of electronic devices. In addition, compared with the sealing way in the related art in which the seal implements the sealing in such a manner that a fit is produced between the seal and the chassis of the electronic device in the direction perpendicular to the mating direction of the electrical connector, the UV seal according to the present application can implement sealing in such a manner that an interference fit is produced between the UV seal and the chassis of the electronic device in the mating direction of the electrical connector, the seal wear caused by the contact friction between the UV seal and the side wall of the port can be reduced, thereby ensuring that the sealing effectiveness can be achieved by the UV seal on the one hand, and prolonging the service life of the seal and saving costs on the other hand. In addition, according to the above technical solution of the present application, the electrical connector can be more compact in structure.

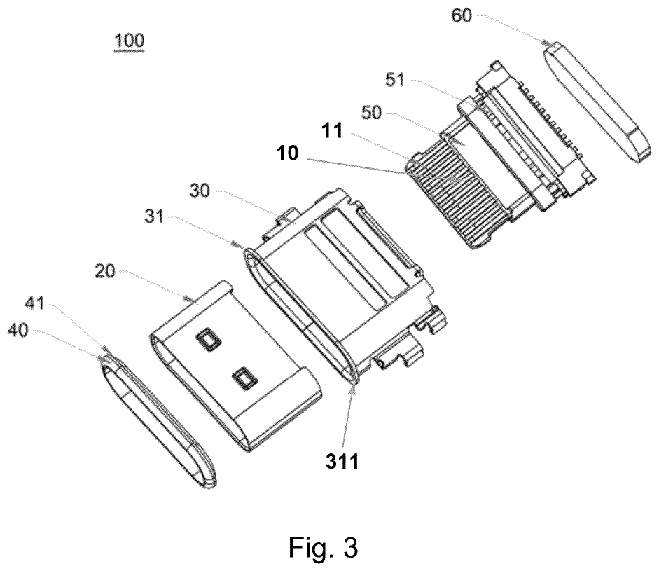

In some embodiments, the mating end of the outer shell 30 may include a flange portion 31 continuously arranged along a circumference direction of the outer shell, wherein the flange portion 31 extends radially towards the outer side of the outer shell and forms a mating end surface 311 of the outer shell for attaching the front seal 40, as shown in FIG. 3. mating end With such configuration, the effect area of the mating end surface of the outer shell, which may function as the support base of the UV seal, can be increased, thereby further ensuring and enhancing the sealing effectiveness of the UV seal.

In some embodiments, as shown in FIGS. 1, 6 and 7, the front seal 40 may be an elastically deformable component, and may be configured to produce elastic deformation when the front seal 40 is inserted into the port of the electronic device and contacts with a chassis of the electronic device, so that an interference fit is produced between the front seal 40 and the chassis of the electronic device in the mating direction. As shown in FIG. 8, the interference fit is produced between the front seal 40 and the chassis of the electronic device in the mating direction (e.g., in the first direction of FIG. 8).

In some embodiments, as shown in FIG. 8, at a rest state, the front seal 40 may have a length of substantially 0.50 mm in the mating direction, and the front seal 40 may be configured to produce an elastic deformation in the range of 0.1 mm to 0.25 mm, preferably 0.15 mm, in the mating direction.

According to the above embodiment of the present application, the UV seal of the electrical connector is configured as an elastically deformable component, such that the UV seal will undergo an elastic deformation when the UV seal contacts with the chassis of the electronic device, and an interference fit is produced between the UV seal and the chassis of the electronic device in the mating direction. Accordingly, a tight and effective seal can be achieved, and environmental contaminants can be prevented from entering the interior of the electronic device from the outside through the port of the electronic device, and thus the safety of the electronic device can be improved.

In some embodiments, as shown in FIGS. 3, 7 and 8, the front seal 40 is configured to have an annular shape in which the front seal 40 continuously extends along the circumference direction around the mating end of the inner shell. In some embodiments, the front seal 40 can be configured to have a first surface 41, a second surface 42 and a third surface 43, wherein the first surface 41 forms a positive fit with the outer sidewall surface of the inner shell 20 that extends beyond the mating end of the outer shell 30, the second surface 42 forms a positive fit with the mating end surface 311 of the outer shell, and the third surface 43 connects the first surface and the second surface.

It should be understood that the term “positive fit” used in the present application may refer to a relationship between two mating parts that are shaped and positioned in such a way as to form an abutting and tight fit against each other.

In the electrical connector according to the exemplary embodiment of the present application, the UV seal is configured to have an annular shape continuously extends along a circumference direction around the mating end of the inner shell 20, and the front seal 40 is configured to have a first surface 41, a second surface 42 and a third surface 43, wherein the first surface 41 forms a positive fit with the outer sidewall surface of the inner shell 20 that extends beyond the mating end of the outer shell 30, the second surface 42 forms a positive fit with the mating end surface of the outer shell 30, and the third surface 43 connects the first surface and the second surface. Thus, a tight fit can be achieved respectively between the UV seal and the outer sidewall surface of the inner shell 20 that extends beyond the mating end of the outer shell 30 and between the UV seal and the mating end surface of the outer shell. Therefore, on the one hand, any gap at a path between the inner shell and the outer shell of the electrical connector can be seamlessly sealed to reduce the risk of environmental contaminants entering the interior of the electrical connector, thereby improving the water resistance property of the electrical connector itself, and on the other hand, the electrical connector with more compact in structure can be achieved.

In some embodiments, the third surface 43 may be in a convex arc shape.

As shown in FIG. 8, a ring-shaped recess 210 for receiving the electrical connector 100 is formed inside the commonly used port of the electronic device 500. A protrusion 220 is arranged in the ring-shaped recess 210, and the protrusion 220 in the ring-shaped recess 210 can be chamfered or rounded. In the ports of some electronic devices, the protrusion 220 in the ring-shaped recess 210 may have surfaces extending in an acute angle or a right angle, for example, 30° or 60°.

According to the above technical solution of the application, the third surface 43 that connects the first surface 41 and the second surface 42 of the UV seal is configured in a convex arc shape, which contributes to an elastic deformation of the UV seal produced when the UV seal contacts with the chassis of the electronic device. Therefore, the UV seal is adapted for forming a tight interference fit with the chassis s of the electronic devices with the aforementioned various configurations, thereby achieving a tight and effective seal. In this regard, the electrical connector according to the present application can be adapted to several electronic devices with various chassis, which greatly improves the versatility and applicability of the electrical connector. In addition, the effective seal contributes to preventing environmental contaminants from entering into the interior of the electronic devices from the outside through the ports of the electronic devices, thereby improving the safety of electronic devices.

In some embodiments, the size of the mating end of the outer shell in the direction perpendicular to the mating direction (as shown in the second direction of FIG. 8) is smaller than the size, in the corresponding direction, of the port of the electronic device into which the electrical connector is to be inserted.

According to the above technical solution of the application, the size of the mating end of the outer shell 30, which may function as the support base of the UV seal, in the direction perpendicular to the mating direction of the electrical connector is configured to be smaller than the size, in the corresponding direction, of the port of the electronic device into which the electrical connector is to be inserted. With such configuration, on the one hand, the requirements for the fit tolerance between the size of the mating end of the outer shell 30 and the size of the port of the electronic device into which the electrical connector is to be inserted are reduced, thereby improving the versatility and wide applicability of electrical connectors, and on the other hand, the electrical connector, especially the UV seal at the mating end of the electrical connector, may not produce a contact friction with the side wall of the port of the electronic device during the inserting/pulling of the electrical connector, as a result, the wear of the UV seal can be reduced, the service life of the UV seal can be prolonged, and, it is not prone for the seal to stripping off after many times of inserting/pulling of the electrical connector over time, which further ensures a high level of sealing performance.

In some embodiments, a rib and/or a groove may be provided on the mating end surface of the outer shell, and a groove and/or a rib may be correspondingly provided on the second surface of the front seal 40 to form a positive fit with the respective rib and/or the respective groove.

In some embodiments, the rib and/or the groove formed on the mating end surface of the outer shell 30 is configured into an integral annular structure extending continuously along the circumference direction of the outer shell 30, or into a plurality of separate sections that are spaced apart from each other along the circumference direction of the outer shell 30. With such configuration, the attachment performance between the UV seal and the mating end surface of the outer shell can be enhanced, thereby reducing the possibility of the detachment of the UV seal while improving the sealing performance of the UV seal at the mating end of the outer shell.

In some embodiments, as shown in FIG. 3, the lead assembly 100 may further include a body portion 50 arranged on a mounting end of the lead assembly opposite to the tongue portion thereof, an opening 51 may be arranged at the body portion and expose the portions of the conductive elements, and a body seal 60 is tightly fit in the opening 51.

As illustrated, a body seal 60 is disposed in the opening 51 of the body portion 50 arranged on the mounting end of the electrical connector. With such configuration, moisture, dust, etc. can be prevented from entering into the interior of the electrical connector from the outside through the opening on the body portion that exposes the portions of conductive elements to cause damage to the portions of conductive elements, thereby in turn improving the safety and water resistance property of the electrical connector.

In some embodiments, the outer shell 30 is provided with a processing window for operating on the portions of the conductive elements, and in an assembly state of the electrical connector, the processing window may correspond to the opening 51 fit with the body seal 60. In some embodiments, the body seal 60 may be made from a water resistance material. For example, optionally, the body seal 60 may be made from water resistance glue.

According to aspects of the present application, UV seal and body seal are provided in the electrical connector and the interference fit is formed between the UV seal and the chassis of electronic devices. With such configuration, the water resistance and dust resistance performance of electronic devices are improved from several aspects, thereby achieving a high level of water resistance performance while achieving electrical connector which is compact in structure.

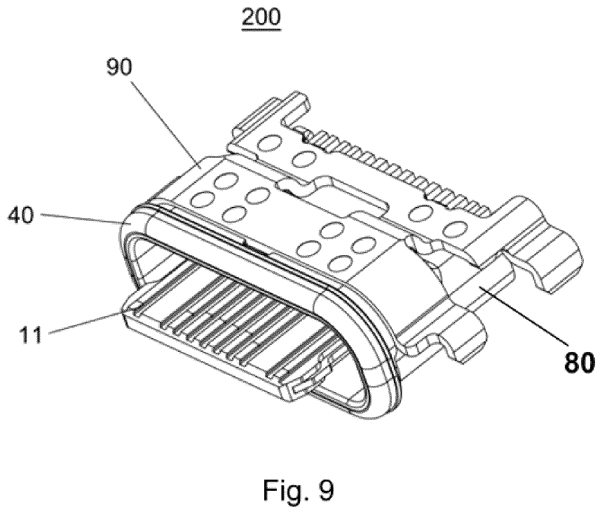

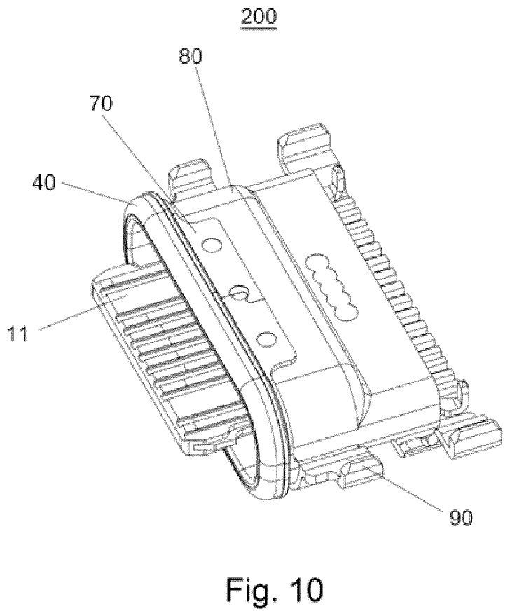

In some embodiments, the inner shell and the outer shell of the electrical connector may have different configurations from those of the inner shell 20 and the outer shell 30 of the electrical connector 100 described with reference to FIGS. 1 to 8 of the present application. FIGS. 9 to 11 show an electrical connector 200 according to another exemplary embodiment of the present application. For the sake of the brevity, the differences between this embodiment and the aforementioned embodiments will be mainly described in detail below. In FIGS. 9 to 11, the same parts as those of the electrical connector 100 shown in FIGS. 1 to 8 are indicated by the same reference numerals. And the description of such same parts can be referred to the previous specific description of the parts in connection with FIGS. 1 to 8. It will not be repeated here.

As shown in FIGS. 9 to 11, the electrical connector 200 according to another exemplary embodiment of the present application includes a inner shell 80 and a front shell 70 disposed on the outside of the inner shell 80.

The inner shell 80 of the electrical connector 200 can be disposed on the outside of the lead assembly 10 and can be configured to cover at least a portion of the lead assembly 10 and expose the tongue portion 11 of the lead assembly 10 from the mating end of the inner shell 80. In the illustrated exemplary embodiment, the inner shell 80 of the electrical connector 200 is configured to have an accommodating cavity enclosed by a side wall, which is hollow. The accommodating cavity of the inner shell 80 includes a mating end accommodating space 81 located at the mating end side of the inner shell 80 and a mounting end accommodating space 82 located at the mounting end side of the inner shell 80. The cross-sectional area of the mating end accommodating space 81 is larger than that of the mounting end accommodating space 82 in the direction perpendicular to the mating direction in which the electrical connector 200 is inserted into the port of the electronic device. The mounting end accommodating space 82 of the inner shell 80 that is smaller can be configured to accommodate the body portion 50 and the body seal 60 of the lead assembly 10 in a sealed manner. The tongue portion 11 of the lead assembly 10 is accommodated in the larger mating end accommodating space 81 of the inner shell 80 and extends from the mating end of the inner shell 80. The mating end of the inner shell 80 is configured to have a shape which is adapted to the port shape of the electronic device, such that the tongue portion 11 exposed therefrom can be easily interfaced with the port of the electronic device.

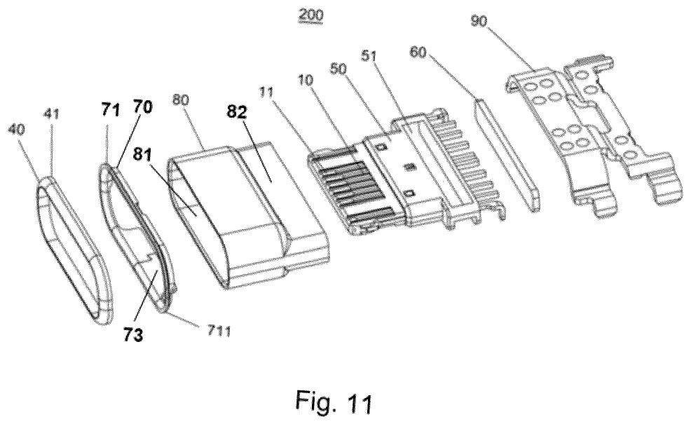

The front shell 70 of the electrical connector 200 is disposed on the outside of the inner shell 80, and the front shell 70 is attached to the outer sidewall surface of the inner shell 80 near the mating end opening. The front shell 70 includes a flange portion 71 located at the mating end side and continuously arranged along the circumference direction of the front shell 70 and an attachment 73 connected with the flange portion 71 and arranged on the mounting end side, wherein the flange portion 71 extends radially towards the outer side of the front shell 70 and forms a mating end surface 711 of the front shell 70, as shown in FIG. 11. The front shell 70 is firmly attached to the outer sidewall surface of the inner shell 80 near the mating end opening via the attachment 73. And the mating end of the inner shell 80 extends beyond the flange portion 71 as the mating end of the front shell 70 in the mating direction in which the electrical connector 200 is inserted into the port of the electronic device. A corner portion (similar to the corner portion 21, as shown in FIG. 7) is formed between the outer sidewall surface of the inner shell 80 that extends beyond the mating end of the front shell 70 and the mating end surface 711 of the front shell 70 which is formed by the flange portion 71. In some embodiments, the front shell 70 may be an annular shell which is made from metal materials, such as iron, aluminum, and their alloys.

In the illustrated exemplary embodiment, the electrical connector 200 can also include a front seal 40 which is arranged at the corner portion. As shown in FIGS. 9 to 11, the front seal 40 is attached to the outer sidewall surface of the inner shell 80 that extends beyond the mating end of the front shell 70 and is also attached to the mating end surface 711 of the front shell 70. In other words, the flange portion 71 of the front shell 70 forms the mating end surface 711 for attaching the front seal 40, as shown in FIG. 11.

According to the exemplary embodiment of the present application, a corner portion is formed between the outer sidewall surface of the inner shell of the electrical connector that extends beyond the mating end of the front shell and the mating end surface of the front shell which is formed by the flange portion 71, and a UV seal is arranged at the corner portion, such that the UV seal is attached to the outer sidewall surface of the inner shell that extends beyond the mating end of the front shell and is also attached to the mating end surface of the front shell. With such configuration, on the one hand, any gap at a path between the inner shell and the front shell of the electrical connector can be seamlessly sealed to reduce the risk of environmental contaminants entering the interior of the electrical connector, and on the other hand, the mating end surface of the front shell is used as the support base for the UV seal, as a result, the UV seal can form an interference fit with the chassis of the electronic device in the mating direction when the tongue portion of the electrical connector is inserted into the port of the electronic device. With such configuration, a tight and effective seal is produced between the electrical connector and the chassis of the electronic device, thereby preventing environmental contaminants from entering into the interior of the electronic device through the port of the electronic device, and thus improving the safety of the electronic device.

According to the above technical solution, a flange portion 71 is continuously arranged on the mating end surface 711 of the front shell 70 along the circumference direction of the front shell 70, the effect area of the mating end surface of the front shell 70, which functions as the support base of the UV seal, can be increased, thereby further ensuring and enhancing the sealing effectiveness of the UV seal.

As shown in FIGS. 9 to 11, the front seal 40 is configured to have an annular shape in which the front seal 40 continuously extends along the circumference direction around the mating end of the inner shell. In some optional embodiments, the front seal 40 can be configured to have a first surface 41, a second surface 42 and a third surface 43, wherein the first surface 41 forms a positive fit with the outer sidewall surface of the inner shell that extends beyond the mating end of the front shell 70, the second surface 42 forms a positive fit with the mating end surface 711 of the front shell, and the third surface 43 connects the first surface and the second surface.

In the electrical connector according to the exemplary embodiment of the present application, the UV seal is configured to have the annular shape continuously extends along a circumference direction around the mating end of the inner shell, and the front seal 40 is configured to have the first surface, the second surface and the third surface, wherein the first surface forms a positive fit with the outer sidewall surface of the mating end of the inner shell, the second surface forms a positive fit with the mating end surface of the outer shell, and the third surface connects the first surface and the second surface. With such configuration, the tight fit respectively between the UV seal and the outer sidewall surface of the inner shell that extends beyond the mating end of the front shell and between the UV seal and the mating end surface of the front shell can be achieved. Therefore, on the one hand, any gap at a path between the inner shell and the front shell of the electrical connector can be sealed seamlessly to reduce the risk of environmental contaminants entering the interior of the electrical connector, thereby improving the water resistance property of the electrical connector itself, and on the other hand, the electrical connector with more compact in structure can be achieved.

In some embodiments, a rib and/or a groove may be arranged on the mating end surface of the front shell, and a groove and/or a rib may be correspondingly provided on the second surface of the front seal 40 to forms a positive fit with the respective rib and/or the respective groove on the mating end surface of the outer shell.

In some embodiments, the rib and/or the groove formed on the mating end surface of the front shell are configured as an integral annular structure extending continuously along the circumference direction of the front shell, or a plurality of separate sections that are spaced apart from each other along the circumference direction of the front shell.

In some embodiments, the electrical connector 200 can also include an additional outer shell 90, which is configured to be attached to the outside of the inner shell 80 and the lead assembly 10 to provide further protection and support for the electrical connector 200.

According to the above technical solution of the present application, the rib and/or the groove are provided on the mating end surface of the front shell, which functions as the support base of the UV seal, and a respective groove and/or respective rib are correspondingly provided on the second surface of the UV seal connected with the mating end surface of the front shell correspondingly. With such configuration, the attachment performance between the UV seal and the mating end surface of the front shell can be enhanced, thereby reducing the possibility of the detachment of the UV seal while improving the sealing performance of the UV seal at the mating end of the front shell.

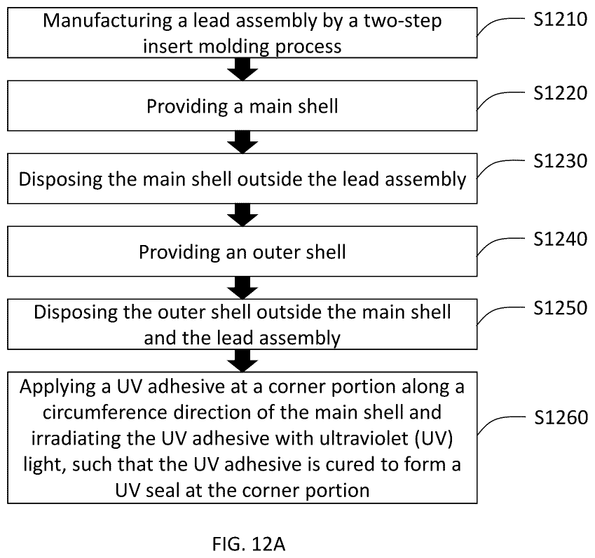

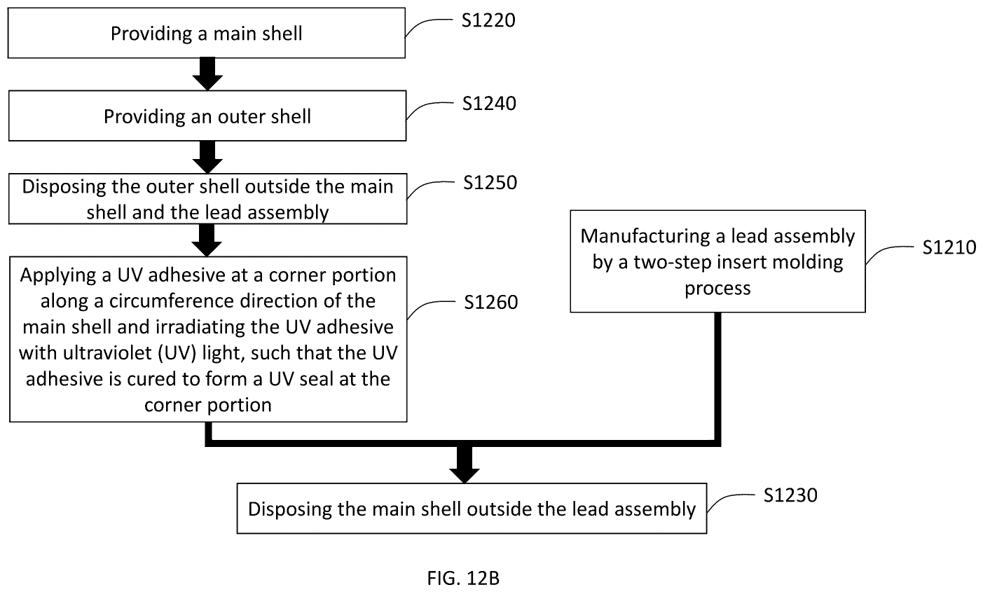

Some aspects of the present application relate to a method for manufacturing an electrical connector. In some embodiments, a method for manufacturing an electrical connector may include steps S1210 to S1260 as shown in FIG. 12A.

As illustrated, in act S1210, the lead assembly (e.g., lead assembly 10) is manufactured by a two-step insert molding process, wherein the lead assembly includes a tongue portion (e.g., tongue portion 11) to be connected to a circuit of an electronic device by inserting the tongue portion into a port of the electronic device and a body portion (e.g., body portion 50) arranged on the mounting end of the lead assembly opposite to the tongue portion thereof.

In act S1220, an inner shell is provided. The inner shell can be a main iron housing made from iron. In some embodiments, the inner shell can be configured as the inner shell 20 shown in FIGS. 1 to 8. In some embodiments, the inner shell can be configured as the inner shell 80 shown in FIGS. 9 to 11.

In act S1230, the inner shell is disposed on the outside of the lead assembly 10 such that the inner shell covers at least a portion of the lead assembly 10 and the tongue portion of the lead assembly is exposed from the mating end of the inner shell.

In act S1240, an outer shell is provided. The outer shell can be an outer iron housing made from iron. In some embodiments, the outer shell 30 may be configured as the outer shell 30 shown in FIGS. 1 to 8. In some embodiments, the outer shell may be configured as the front shell 70 as shown in FIGS. 9 to 11.

In act S1250, the outer shell is disposed on the outside of the inner shell, wherein the outer shell is disposed such that: the mating end of the inner shell extends beyond the mating end of the outer shell in the mating direction in which the electrical connector is inserted into the port of the electronic device, and a corner portion is formed between the outer sidewall surface of the inner shell that extends beyond the mating end of the outer shell and the mating end surface of the outer shell.

In some embodiments, as shown in FIGS. 1 to 8, the outer shell 30 can be disposed on the outside of the inner shell 20 and the lead assembly 10, such that the inner shell 20 and the lead assembly 10 are accommodated in the outer shell 30. And the outer shell 30 is disposed such that: the mating end of the inner shell 20 extends beyond the mating end of the outer shell 30 in the mating direction in which the electrical connector is inserted into the port of the electronic device, and a corner portion is formed between the outer sidewall surface of the inner shell 20 that extends beyond the mating end of the outer shell 30 and the mating end surface of the outer shell 30.

In some embodiments, as shown in FIGS. 9 to 11, the outer shell as the front shell 70 is disposed on the outside of the inner shell 80, and the outer shell is attached to the outer sidewall surface of the inner shell 80 near the mating end opening. The front shell 70 is disposed such that: the mating end of the inner shell 80 extends beyond the flange portion 71 as the mating end of the front shell 70 in the mating direction in which the electrical connector 200 is inserted into the port of the electronic device, and a corner portion is formed between the outer sidewall surface of the inner shell 80 that extends beyond the mating end of the front shell 70 and the mating end surface 711 of the front shell 70 which is formed by the flange portion 71.

In act S1260, UV adhesive is applied at the corner portion along the circumference direction of the inner shell, and the UV adhesive is irradiated with ultraviolet light such that the UV adhesive is cured to form a front seal 40 at the corner portion 31. The front seal 40 is attached to the outer sidewall surface of the inner shell that extends beyond the mating end of the outer shell and is also attached to the mating end surface of the outer shell. As an exemplary embodiment, the corner portion is the corner portion 21 formed between the outer sidewall surface of the inner shell 20 that extends beyond the mating end of the outer shell 30 and the mating end surface of the outer shell 30 as shown in FIGS. 1 to 8. As another exemplary embodiment, the corner portion is the corner portion formed between the outer sidewall surface of the inner shell 80 that extends beyond the mating end of the front shell 70 and the mating end surface 711 of the front shell 70 which is formed by the flange portion 71 as shown in FIGS. 9 to 11.

In some embodiments, UV adhesive is applied at the corner portion formed between the inner shell and the outer shell disposed on the outside of the inner shell along the circumference direction of the inner shell, and the UV adhesive is irradiated with ultraviolet light. With such method, the UV adhesive is cured to form a front seal 40 at the corner portion 31, the UV seal is attached to the outer sidewall surface of the inner shell that extends beyond the mating end of the outer shell on the one hand and is also attached to the mating end surface of the outer shell on the other hand.

In some embodiments, the front seal 40 can be made from a commercially available UV curable adhesive (for example, Hongjin UV5192), which may be referred to as UV adhesive. UV curable adhesive has good adhesion to plastic, metal, glass, etc. It has the characteristics of low odor and low irritation. UV curable adhesive can be quickly cured to elastic adhesive film under UV irradiation. It has the characteristics of high bonding strength, vibration resistance, high temperature resistance and good durability. It is widely used in electronic device connectors, adapters, industrial seals and other products. It functions sealing, dust-proof, water resistance or like in industrial electronic devices mainly. And UV curable adhesive is environmentally friendly and pollution-free, which does not contain solvent. Therefore, the UV seal of the electrical connector according to the exemplary embodiment of the present application does not generate volatile organic compounds (VOC), and thus it is environmentally friendly.

According to the above technical solution of the application, the UV seal of the electrical connector is formed by irradiating the UV adhesive with ultraviolet light and in turn curing the UV adhesive. Due to the fast-curing-speed of the UV adhesive, the UV adhesive can be cured in a few seconds to tens of seconds, as a result, the UV seal can be rapidly manufactured, which contributes to the automatic production line, and thus improving the labor productivity.

It should be understood that the order of the acts of the method for manufacturing electrical connector described in the embodiment of the present application, such as acts S1210 to S1260, are exemplary, and these acts can be performed in different order, which is not limited in the present application.

In some embodiments, as shown in FIG. 12B, act S1210 of manufacturing a lead assembly by a two-step insert molding process can be performed in parallel with steps S1220, S1240, S1250 and S1260, before act S1230. For example, the method can include: act S1210 of manufacturing a lead assembly by a two-step insert molding process; and act S1220 of providing a inner shell, which can be performed in parallel to act S1210.

In some embodiments, the inner shell can be configured as the inner shell 20 shown in FIGS. 1 to 8. In some embodiments, the inner shell can be configured as the inner shell 80 shown in FIGS. 9 to 11.

Continuing with reference to FIG. 12B, the method can also include: act S1240 of providing an outer shell. In some embodiments, the outer shell may be configured as the outer shell 30 shown in FIGS. 1 to 8. In some embodiments, the outer shell may be configured as the front shell 70 as shown in FIGS. 9 to 11.

In some embodiments, the providing the outer shell in act S1240 may include: forming a flange portion continuously at the mating end of the outer shell along the circumference direction of the outer shell, wherein the flange portion extends radially towards the outer side of the outer shell and forms a mating end surface of the outer shell for attaching the UV seal.

In some embodiments, as shown in FIGS. 1 to 8, a flange portion 31 may be continuously formed at the mating end of the outer shell 30 along the circumference direction of the outer shell 30, and the flange portion 31 extends radially towards the outer side of the outer shell 30 and forms a mating end surface of the outer shell 30 for attaching the front seal 40.

In some embodiments, as shown in FIGS. 9 to 11, the flange portion 71 can be continuously arranged at the mating end of the front shell 70 along the circumference direction of the front shell 70, and the flange portion 71 extends radially towards the outer side of the front shell 70 and forms the mating end surface 711 of the front shell 70.

In act S1250, the outer shell is disposed on the outside of the inner shell, wherein the outer shell is disposed such that: the mating end of the inner shell extends beyond the mating end of the housing body in the mating direction in which the electrical connector is inserted into the port of the electronic device, and a corner portion is formed between the outer sidewall surface of the inner shell that extends beyond the mating end of the outer shell and the mating end surface of the outer shell.

In some embodiments, as shown in FIGS. 1 to 8, the outer shell 30 can be disposed on the outside of the inner shell 20 and the lead assembly 10, such that the inner shell 20 and the lead assembly 10 are accommodated in the housing 30, and the outer shell 30 is disposed such that: the mating end of the inner shell 20 extends beyond the mating end of the outer shell 30 in the mating direction in which the electrical connector is inserted into the port of the electronic device, and a corner portion is formed between the outer sidewall surface of the inner shell 20 that extends beyond the mating end of the outer shell 30 and the mating end surface of the outer shell 30.

In some embodiments, as shown in FIGS. 9 to 11, the outer shell used as the front shell 70 is disposed on the outside of the inner shell 80, and the outer shell is attached to the outer sidewall surface of the inner shell 80 near the mating end opening. The front shell 70 is disposed such that: the mating end of the inner shell 80 extends beyond the flange portion 71 as the mating end of the front shell 70 in the mating direction in which the electrical connector 200 is inserted into the port of the electronic device, and a corner portion is formed between the outer sidewall surface of the inner shell 80 that extends beyond the mating end of the front shell 70 and the mating end surface 711 of the front shell 70 which is formed by the flange portion 71.

Next, in act S1260, UV adhesive is applied at the corner portion along the circumference direction of the inner shell, and the UV adhesive is irradiated with ultraviolet light such that the UV adhesive is cured to form a front seal 40 at the corner portion 31. The front seal 40 is attached to the outer sidewall surface of the inner shell that extends beyond the mating end of the outer shell and is also attached to the mating end surface of the outer shell. As an exemplary embodiment, as shown in FIGS. 1 to 8, the front seal 40 is attached to the outer sidewall surface of the inner shell 20 that extends beyond the mating end of the outer shell 30, and is also attached to the mating end surface of the outer shell 30. As another exemplary embodiment, as shown in FIGS. 9 to 11, the front seal 40 is attached to the outer sidewall surface of the inner shell 80 that extends beyond the mating end of the front shell 70, and is also attached to the mating end surface 711 of the front shell 70 which is formed by the flange portion 71.

In some embodiments, UV adhesive is applied at the corner portion formed between the inner shell and the outer shell (/front shell) disposed on the outside of the inner shell along the circumference direction of the inner shell, and the UV adhesive is irradiated with ultraviolet light. With such method, the UV adhesive is cured to form a UV seal at the corner portion, which on the one hand is attached to the outer sidewall surface of the inner shell that extends beyond the mating end of the outer shell (/front shell) and on the other hand is also attached to the mating end surface of the outer shell (/front shell). In this way, any gap at a path between the inner shell and the outer shell (/front shell) of the electrical connector can be sealed seamlessly to reduce the risk of environmental contaminants entering the interior of the electrical connector.

In act S1230, when a UV seal has been formed at the corner portion of the inner shell and the outer shell which are disposed together, the UV seal assembly is disposed integrally on the outside of the lead assembly, such that the inner shell in the UV seal assembly covers at least a portion of the lead assembly and the tongue portion of the lead assembly is exposed from the mating end of the inner shell. In some embodiments, the body portion 50 of the lead assembly 10 is configured with a portion that exposes portions of the conductive elements to facilitate the operation on the portions of the conductive elements. In such embodiment, in act S1240, the providing the outer shell can include configuring a processing window for operating on the portions of the conductive elements of the lead assembly on the housing.

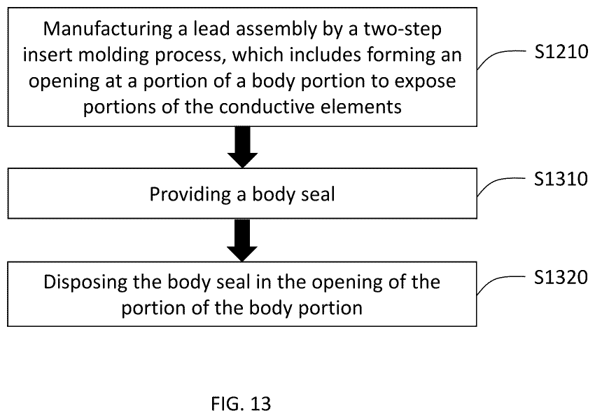

In order to protect the exposed portions of the conductive elements of the lead assembly 10, the portions of the conductive elements on the body portion 50 of the lead assembly 10 may be sealed. In some embodiments, in act S1210, the manufacturing the lead assembly 10 by two-step insert molding can include: configuring an opening 51 at the portion of the body portion 50 that exposes the portions of the conductive elements. In such embodiment, as shown in FIG. 13, the method for manufacturing the electrical connector according to the present application can also include: act S1310 of providing a body seal 60; and act S1320 of disposing the body seal 60 in the opening 51 of the body portion 50, such that the body seal 60 completely covers the portions of the conductive elements exposed from the body portion 50.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a lead assembly comprising a body portion and a plurality of conductive elements held by the body portion;
an inner shell disposed outside the lead assembly, the inner shell at least partially enclosing the body portion of the lead assembly and comprising a mating end;
an outer shell disposed outside the inner shell and connected to the inner shell at selected locations, the outer shell comprising a mating end, wherein the mating end of the inner shell extends beyond the mating end of the outer shell; and
a seal attached to both the inner shell and the outer shell.

2. The electrical connector of claim 1, comprising:
a corner portion between a surface of the mating end of the inner shell and a surface of the mating end of the outer shell,
wherein the seal is disposed in the corner portion.

3. The electrical connector of claim 1, wherein:
the seal is attached to at least a portion of a surface of the mating end of the inner shell, and
the portion of the surface of the inner shell extends, in the mating direction, beyond the outer shell.

4. The electrical connector of claim 3, wherein:
the seal is attached to at least a portion of a surface of the mating end of the outer shell, and
the surface of the outer shell is transverse to the surface of the inner shell.

5. The electrical connector of claim 1, wherein:
the seal is made from a UV curable adhesive.

6. The electrical connector of claim 1, wherein:
the mating end of the outer shell comprises a flange portion extending outward of the outer shell; and
the corner portion is between the surface of the mating end of the inner shell and a surface of the flange portion of the mating end of the outer shell.

7. The electric connector of claim 1, wherein:
the seal is elastically deformable.

8. The electric connector of claim 7, wherein:
the seal has a length of substantially 0.50 mm in the mating direction at a rest state; and
the seal is configured to produce an elastic deformation, in the mating direction, in a range of 0.10 mm to 0.25 mm.

9. The electrical connector of claim 1, wherein:
the body portion of the lead assembly comprises an opening that exposes portions of the plurality of conductive elements; and
the electrical connector comprises a body seal disposed in the opening of the body portion of the lead assembly.

10. The electrical connector of claim 9, wherein:
the outer shell comprises a window aligned with the opening of the body portion of the lead assembly.

11. The electric connector of claim 1, wherein:
the lead assembly comprises a tongue portion extending from the body portion in a mating direction and exposed at the mating end of the inner shell.

12. An electrical connector comprising:
an outer shell comprising a mating end;
an inner shell disposed in the outer shell and comprising a mating end extending beyond the mating end of the outer shell;
a lead assembly comprising a body portion at least partially disposed in the inner shell and a plurality of conductive elements held by the body portion; and
a seal disposed on a surface of the mating end of the inner shell so as to block a path between the mating end of the inner shell and the mating end of the outer shell.

13. The electrical connector of claim 12, wherein:
the seal comprises a first surface attached to the surface of the mating end of the inner shell, a second surface attached to a surface of the mating end of the outer shell, and a third surface connecting the first surface and the third surface; and
the third surface is within a perimeter of the outer shell.

14. The electrical connector of claim 13, wherein:
the third surface of the seal is configured to deform in a mating direction when the electrical connector is mated with a port of an electronic device.

15. The electrical connector of claim 12, wherein:
the outer shell comprises a front portion and a rear portion separate from the front portion;
the front portion comprises the mating end of the outer shell; and
the rear portion comprises mounting tails.

16. The electrical connector of claim 12, further comprising:
connected spots between the outer shell and the inner shell.

17. The electrical connector of claim 12, wherein:
the inner shell comprises a mounting end opposite the mating end; and
the mating end of the inner shell has a cross-sectional area larger than that of the mounting end.

18. An electronic device comprising:
a chassis comprising a port; and
an electrical connector mated with the chassis, the electrical connector comprising:
an outer shell comprising a mating end facing the port of the chassis;
an inner shell disposed in the outer shell and comprising a mating end facing the port of the chassis and extending beyond the mating end of the outer shell;
a plurality of conductive elements at least partially disposed in the inner shell; and
a seal attached to both the inner shell and the outer shell and abutting the chassis.

19. The electronic device of claim 18, wherein:
the chassis comprises a recess; and
the seal of the electrical connector is disposed in the recess.

20. The electronic device of claim 19, wherein:
the chassis comprises a protrusion in the recess; and
the protrusion engages the seal of the electrical connector.
